(19) United States
(12) Patent Application Publication
(10) Pub. No.: US 2008/0081174 A1
(43) Pub. Date: Apr. 3, 2008

(54) Optical Protection Sheet, Method for Manufacturing the Same, and Liquid Crystal Display Having the Same

(76) Inventor: Seung Je Lee, Seongnam-Si (KR)

Correspondence Address: F. CHAU & ASSOCIATES, LLC, 130 WOODBURY ROAD, WOODBURY, NY, 11797, US

(21) Appl. No.: 11/863,995

(22) Filed: Sep. 28, 2007

(30) Foreign Application Priority Data
Sep. 29, 2006 (KR) 10-2006-0095439

(51) Int. Cl. B32B 3/26; B05D 5/00; G02F 1/1335

(52) U.S. Cl. 428/315.5; 349/112; 427/245

(57) ABSTRACT

An optical protection sheet includes a foamy resin layer. The optical protection sheet includes a base film containing a light diffusion material and the foamy resin layer formed on the base film and containing micro-bubbles.

### CROSS-REFERENCE TO RELATED APPLICATION

This application claims priority to Korean Patent Application No. 10-2006-0095439, filed on 29 Sep. 2006, in the Korean Intellectual Property Office, the disclosure of which is herein incorporated by reference in its entirety.

### BACKGROUND OF THE INVENTION

1. Field of the Invention

The present invention relates to an optical protection sheet, a method for manufacturing the same, and a liquid crystal display having the same, and more particularly, to an optical protection sheet using a foamy resin layer, a method for manufacturing the same, and a liquid crystal display having the same.

2. Description of Related Art

The range of applications for a liquid crystal display (LCD) are wide due to features such as lightweight, slim structure, low power drive, full-color, and high resolution. The range of applications for LCD technology includes computers, notebook computers, personal digital assistance (PDAs), phones, televisions, audio/video equipment and the like. Such an LCD controls an amount of transmitted light according to image signals applied to a plurality of control switches arranged in a matrix form, thereby displaying a desired image on a liquid crystal display panel of the LCD.

Since the LCD cannot emit light by itself, a light source such as a backlight unit may be implemented. Light emitted from a backlight unit as a light source is condensed and diffused through a plurality of optical sheets arranged above the backlight unit so that the emitted light can be uniformly provided over an entire region of the liquid crystal display panel of the LCD.

The plurality of optical sheets may be provided as a diffusion plate, a prism sheet and a protection sheet. The diffusion plate substantially prevents local concentration of light by dispersing light, and the prism sheet disposed on the diffusion plate condenses the light, which has been diffused from the diffusion plate, in a direction perpendicular to a plane of the liquid crystal display panel of the LCD. The protection sheet is disposed on the prism sheet to protect the prism sheet.

Typically, a protection sheet used in an LCD is configured in such a manner that beads are scattered on a surface of the protection sheet to prevent close contact with a liquid crystal display panel of the LCD and to improve a light scattering property.

When a strong impact or vibration is absorbed by an LCD with the protection she et configured as above, there is a problem in that the beads scattered on the surface of the protection sheet are separated from the protection sheet, or the beads of the protection sheet are rubbed against a polarizer attached to an outer side of a liquid crystal display panel of the LCD, resulting in scratches and the like on a surface of the polarizer. The scratches may lead to defects, such as white spots on a screen when an image is displayed on the liquid crystal display.

### SUMMARY OF THE INVENTION

According to one embodiment of the present invention, an optical protection sheet comprises a base film comprising a light diffusion material and a foamy resin layer formed on the base film and containing micro-bubbles.

The base film may comprise polyethylene terephthalate (PET).

The light diffusion material may comprises beads made of a polymeric compound.

The beads may have a diameter of about 1 to 3 μm.

The base film may have a thickness of about 50 to 100 μm.

The foamy resin layer may have a thickness of about 20 to 30 μm.

The foamy resin layer comprises a foamy polyester resin, a foamy polyolefin resin or a foamy acrylonitrile butadiene styrene (ABS) resin.

According to another embodiment of the present invention, a method for manufacturing an optical protection sheet comprises mixing a light diffusion material with a resin, forming a mixture of the light diffusion material and the resin into a base film through a rolling process, applying a foamy resin on the base film, and heat-treating an applied foamy resin to form a foamy resin layer containing micro-bubbles.

The resin may include polyethylene terephthalate (PET).

The light diffusion material may comprise beads made of a polymeric compound.

The beads may have a diameter of about 1 to 3 μm.

The step of forming the base film may comprise the step of forming a base film with a thickness of about 50 to 100 μm.

The step of forming the foamy resin layer may comprise the step of forming a foamy resin layer with a thickness of about 20 to 30 μm.

The foamy resin comprises a foamy polyester resin, a foamy polyolefin resin or a foamy acrylonitrile butadiene styrene (ABS) resin.

According to another embodiment of the present invention, a liquid crystal display comprises a liquid crystal display panel with polarizers attached to outer surfaces there of, a light source unit disposed below the liquid crystal display panel to provide light to the liquid crystal display panel, and a plurality of optical sheets disposed between the liquid crystal display panel and the light source unit, wherein the plurality of optical sheets comprise an optical protection sheet including a base film comprising a light diffusion material and a foamy resin layer formed on the base film and containing micro-bubbles.

The plurality of optical sheets may further comprise a diffusion sheet and a prism sheet and are arranged such that the diffusion sheet, the prism sheet and the optical protection sheet are sequentially stacked up.

The liquid crystal display may further comprise a light guide plate disposed below the plurality of optical sheets, and the light source unit may comprise a light source disposed on at least one side of the light guide plate, and a reflector disposed around the light source.

The light source unit may comprise a plurality of lamps, and the plurality of lamp are arranged to be spaced apart from one another at predetermined intervals below the plurality of optical sheets.

### BRIEF DESCRIPTION OF THE DRAWINGS

The present invention will become apparent from the following description of preferred embodiments given in conjunction with the accompanying drawings, in which:

FIG. 1 is a schematic sectional view of an optical protection sheet according to an exemplary embodiment of the present invention;

FIGS. 2A to 2E are sectional views illustrating a process of manufacturing an opt ical protection sheet according to an exemplary embodiment of the present invention;

FIGS. 3 and 4 are an exploded perspective view of a liquid crystal display having the optical protection sheet according to an exemplary embodiment of the present invention, and a sectional view taken along line I-I, respectively; and

FIGS. 5 and 6 are an exploded perspective view of a liquid crystal display having the optical protection sheet according to another exemplary embodiment of the present invention, and a sectional view taken along line II-II, respectively.

### DETAILED DESCRIPTION OF PREFERRED EMBODIMENTS

Hereinafter, preferred embodiments of the present invention will be described in detail with reference to the accompanying drawings.

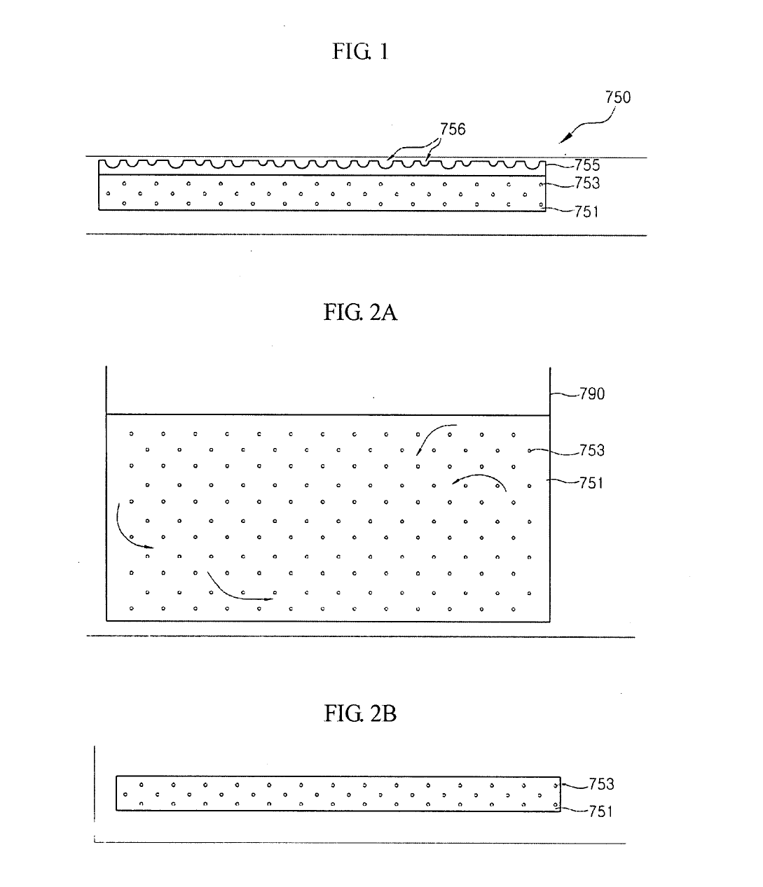

FIG. 1 is a sectional view of an optical protection sheet according to an exemplary embodiment of the present invention.

Referring to FIG. 1, an optical protection sheet 750 includes a base film 751, diffusion materials 753 and a foamy resin layer 755.

The base film 751 is formed of a plastic resin, such as polyethylene terephthalate (PET), to have a thickness of 50 to 100 μm. The base film 751 contains the diffusion materials 753 therein. Beads made of a polymeric compound, e.g., an organic substance such as silicone or acryl, can be used as the diffusion materials 753. Beads with a diameter of about 1 to 3 μm can be used.

The foamy resin layer 755 is formed on the base film 751 containing the diffusion materials 753. The foamy resin layer 755 includes micro-bubbles 756 formed therein through a foaming process. The foamy resin layer 755 can be formed to have a thickness of about 20 to 30 μm.

Furthermore, a foamy polyester resin, a foamy polyolefin resin or a foamy acrylonitrile butadiene styrene (ABS) resin can be used as a material for the foamy resin layer 755, and various types of foamy resins other than the aforementioned resins may be used.

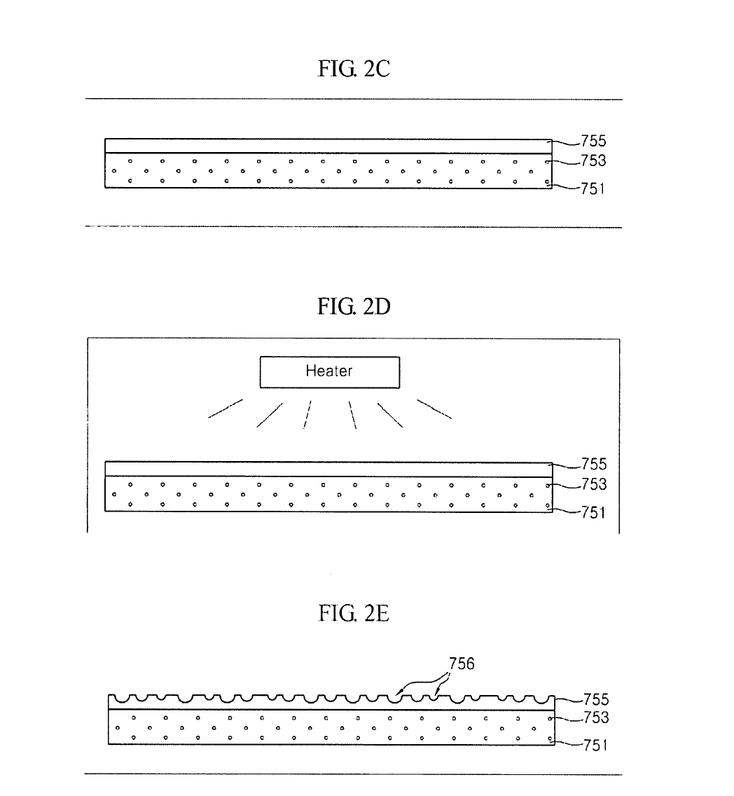

FIGS. 2A to 2E are sectional views illustrating a process of manufacturing the optical protection sheet according to an exemplary embodiment of the present invention. The process of manufacturing the optical protection sheet will be described with reference to FIGS. 2A to 2E.

A certain amount of resin 751 and the diffusion materials 753 are loaded into a tank 790 and mixed together so that the diffusion materials 753 can be uniformly dispersed in the resin 751 (see FIG. 2A).

A plastic resin such as polyethylene terephthalate (PET) is used for the resin 751 as described with reference to FIG. 1, and beads made of a polymeric compound, e.g., an organic material such as silicone or acryl, can be used as the diffusion materials 753. Beads with a diameter of about 1 to 3 μm can be used.

Referring to FIG. 2B, the mixture of the diffusion materials 753 and the resin 751 is stretched in the form of a thin film through a rolling process, thereby forming the base film 751. The base film 751 is formed to have a thickness of about 50 to 100 μm.

Referring to FIG. 2C, a foamy resin is applied to the base film 751 containing the diffusion materials 753. Here, a foamy polyester resin, a foamy polyolefin resin or a foamy acrylonitrile butadiene styrene (ABS) resin can be used as the foamy resin, and various types of foamy resins other than the aforementioned resins may be used.

Referring to FIGS. 2D and 2E, the applied foamy resin is subjected to heat treatment at a predetermined temperature for a predetermined period of time using a heating de vice such as a heater. The period of time and temperature for the heat treatment can vary depending on the type of the applied foamy resin, the size of micro-bubbles, and the like. When the foamy resin is subjected to the heat treatment, micro-bubbles 756 with predetermined sizes are formed through foaming, resulting in the foamy resin layer 755 with the micro-bubbles 756 distributed on a surface thereof as shown in FIG. 2E. At this time, the foamy resin layer 755 is preferably formed to have a thickness of about 20 to 30 μm.

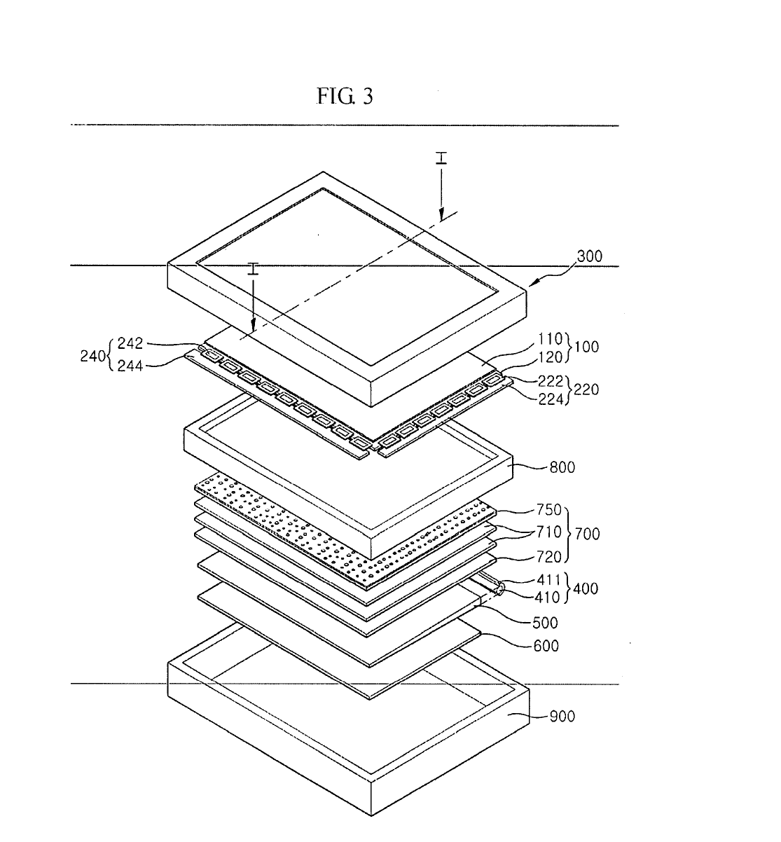

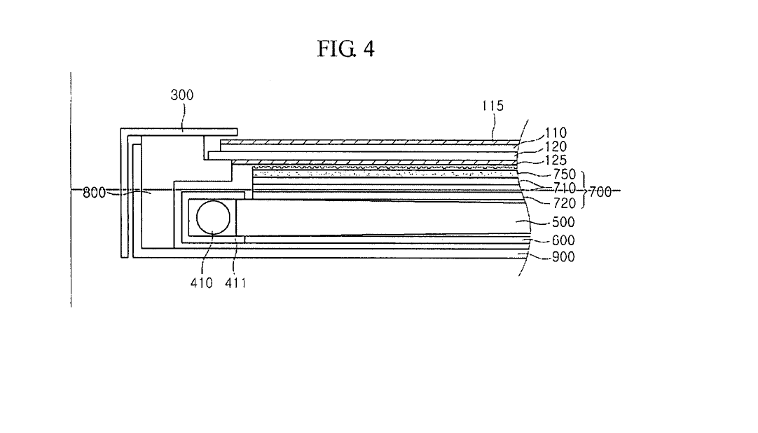

FIGS. 3 and 4 are an exploded perspective view of a liquid crystal display having the optical protection sheet according to an embodiment of the present invention, and a sectional view taken along line I-I, respectively.

An edge type liquid crystal display illustrated in FIGS. 3 and 4 comprises an upper chassis 300, a liquid crystal display panel 100, driving circuits 220 and 240, a plurality of optical sheets 700, a lamp unit 400, a light guide plate 500, a reflection plate 600, a mold frame 800, and a lower chassis 900.

A certain receiving space is formed within a mold frame 800, and a backlight unit comprising the plurality of optical sheets 700, the lamp unit 400, the light guide plate 500 and the reflection plate 600 is disposed in the receiving space of the mold frame 800. The liquid crystal display panel 100 for displaying an image thereon is disposed above the backlight unit. Polarizers 115 and 125 are attached to both outer surfaces of the liquid crystal display panel 100 (see FIG. 4).

The driving circuits 220 and 240 are connected to the liquid crystal display panel 100, and comprise a gate-side printed circuit board 224 with a control integrated circuit (IC) mounted thereon to apply gate signals to gate lines of a thin film transistor (TFT) substrate 120, a data-side printed circuit board 244 with a control IC mounted thereon to apply data signals to data lines of the TFT substrate 120, a gate-side flexible printed circuit board 222 for connecting the TFT substrate 120 and the gate-side printed circuit board 224 to each other, and a data-side flexible printed circuit board 242 for connecting the TFT substrate 120 and the data-side printed circuit board 244 to each other.

Furthermore, driving ICs (not drawn) are mounted on the flexible printed circuit boards 222 and 242 to transmit signals, e.g., RGB (Red, Green and Blue) signals, generated from the printed circuit boards 224 and 244, digital power and the like to the liquid crystal display panel 100.

The lamp unit 400 comprises a lamp 410 and a lamp reflector 411. A cold cathode fluorescent lamp may be used as the lamp 410. Furthermore, the lamp 410 may be “I”-shaped as illustrated in the figures. However, the lamp 410 is not limited to the “I” shape but may have various shapes. The lamp reflector 411 increases the utilization efficiency of light by causing light, which is radially generated from the cold cathode fluorescent lamp, to be reflected and emitted in one direction.

The light guide plate 500 is coupled with the lamp reflector 411 to convert the light with an optical distribution in the form of a line light source, which is generated from the lamp unit 400, into a light with an optical distribution in the form of a surface light source. A plate with high reflectivity is used as the reflection plate 600, and the reflection plate 600 is installed to be in contact with an inside surface of the lower chassis 900. On the other hand, the reflection plate 600 may be omitted by forming a material with high reflection efficiency on the floor surface of the lower chassis 900.

The plurality of optical sheets 700 include a diffusion plate 720, first and second prism sheets 710 and an optical protection sheet 750.

The diffusion plate 720 substantially prevents local concentrations of light by spreading incident light from the light guide plate 500, and simultaneously carries out the function of decreasing an inclination angle of light, which travels toward the first prism sheet, with respect to the first prism sheet.

The first and second prism sheets 710 are constructed such that triangular prisms are formed thereon in predetermined arrays. The first and second prism sheets are disposed such that the prisms thereof cross each other. The first and second prism sheets 710 perform the function of condensing the diffused light from the diffusion plate 720 in a direction perpendicular to a plane of the liquid crystal display panel 100. Although two prism sheets are used in this embodiment, the number of the prism sheets is not limited thereto, for example, one prism sheet may be used.

As explained above, the optical protection sheet 750 comprises the base film 751 containing the diffusion materials 753, and the foamy resin layer 755 formed on the base film 751 through a foaming process and containing the micro-bubbles 756. The optical protection sheet 750 with the aforementioned structure is disposed on the first and second prism sheets 710 so as to simultaneously perform both the function of protecting the prism sheets and the function of causing light to be uniformly diffused using the diffusion materials 753 contained in the base film 751 so that the light can be incident on the liquid crystal display panel 100.

Since the upper portion of the optical protection sheet 750 is formed of the foamy resin layer 755 containing the micro-bubbles 756, which has relatively lower hardness a compared with beads, it is possible to substantially prevent frictional damage from contact between the upper portion of the optical protection sheet 750 and the polarizer 125 attached to the outer surface of the liquid crystal display panel 100, for example, due to absorption of an impact or vibration by the LCD.

The upper chassis 300 is fastened to the mold frame 800 to cover edge portions of the liquid crystal display panel 100, i.e., non-display regions, and side surfaces and a part of a lower surface of the mold frame 800. The lower chassis 900 is installed below the mold frame 800 closing the receiving space of the mold frame.

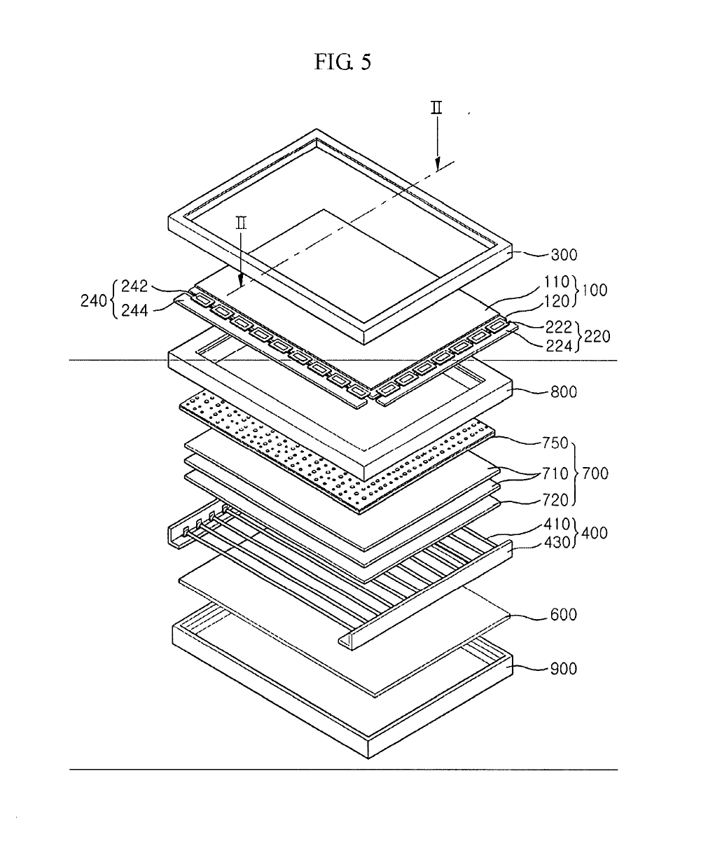

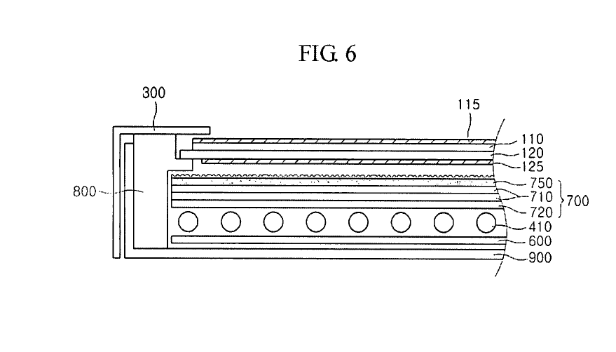

FIGS. 5 and 6 are an exploded perspective view of an LCD having the optical protection sheet according to another exemplary embodiment of the present invention, and a sectional view taken along line II-II, respectively.

An LCD illustrated in FIGS. 5 and 6 is different from the LCD of FIGS. 3 and 4 in that it is a direct type LCD, for example, of the type employed in a large-sized information display apparatus. Only components differing from FIGS. 3 and 4 will be described below with reference to FIGS. 5 and 6, other components are substantially identical to those of the liquid crystal display of FIGS. 3 and 4.

The liquid crystal display comprises an upper chassis 300, a liquid crystal display panel 100, driving circuits 220 and 240, a mold frame 800, a plurality of optical sheets 700, a lamp unit 400, a reflection plate 600, and a lower chassis 900.

An optical protection sheet 750, a prism sheet 710, a diffusion plate 720, at least one lamp unit 400 and the reflection plate 600 are sequentially stacked up from a bottom face of a receiving space defined in a lower portion of the mold frame 800 and are coupled with the mold frame 800. A lower chassis 900 is formed to support the components. The lamp unit 400 includes a plurality of bar type lamps 410 arranged substantially in parallel, and lamp supports 430.

According to an exemplary embodiment of the present invention described above, the use of the optical protection sheet in which the foamy resin layer containing micro-bubbles is formed on the base film containing the diffusion materials agent substantially pr events damage to the optical protection sheet upon absorption of an impact or vibration by an LCD, thereby improving product reliability.

Furthermore, when the optical protection sheet constructed as above is used in an LCD, it is possible to substantially prevent damage that may be caused by frictional contact between the optical protection sheet and a polarizer of a liquid crystal display panel up on absorption of an impact or vibration by the LCD.

The above description has been made only by way of example in connection with exemplary embodiments of the optical protection sheet, the method for manufacturing the same, and the liquid crystal display having the same according to the present invention. It will be readily understood by those skilled in the art that the present invention is not limited thereto and the technical spirit of the present invention covers various modifications and changes made without departing from the scope of the disclosure.

What is claimed is:

1. An optical protection sheet, comprising:
a base film comprising a light diffusion material; and
a foamy resin layer formed on the base film and containing micro-bubbles.

2. The optical protection sheet as claimed in claim 1, wherein the base film comprises polyethylene terephthalate (PET).

3. The optical protection sheet as claimed in claim 1, wherein the light diffusion material comprises beads made of a polymeric compound.

4. The optical protection sheet as claimed in claim 3, wherein the beads have a diameter of about 1 to 3 μm.

5. The optical protection sheet as claimed in claim 1, wherein the base film ha a thickness of about 50 to 100 μm.

6. The optical protection sheet as claimed in claim 1, wherein the foamy resin layer has a thickness of about 20 to 30 μm.

7. The optical protection sheet as claimed in claim 1, wherein the foamy resin layer comprises a foamy polyester resin, a foamy polyolefin resin or a foamy acrylonitrile butadiene styrene (ABS) resin.

8. A method for manufacturing an optical protection sheet, comprising the steps of:
mixing a light diffusion material with a resin;
forming a mixture of the light diffusion material and the resin into a base film through a rolling process,
applying a foamy resin on the base film; and
heat-treating an applied foamy resin to form a foamy resin layer containing micro-bubbles.

9. The method as claimed in claim 8, wherein the resin includes polyethylene terephthalate (PET).

10. The method as claimed in claim 8, wherein the light diffusion material comprises beads made of a polymeric compound.

11. The method as claimed in claim 10, wherein the beads have a diameter of about 1 to 3 μm.

12. The method as claimed in claim 8, wherein forming the base film comprises forming a base film with a thickness of about 50 to 100 μm.

13. The method as claimed in claim 8, wherein forming the foamy resin layer comprises forming a foamy resin layer with a thickness of about 20 to 30 μm.

14. The method as claimed in claim 8, wherein the foamy resin comprises a foamy polyester resin, a foamy polyolefin resin or a foamy acrylonitrile butadiene styrene (ABS) resin.

15. A liquid crystal display, comprising:
a liquid crystal display panel with polarizers attached to outer surfaces thereof;
a light source unit disposed below the liquid crystal display panel to provide light to the liquid crystal display panel; and
a plurality of optical sheets disposed between the liquid crystal display panel and the light source unit,
wherein the plurality of optical sheets comprise an optical protection sheet including a base film comprising a light diffusion material and a foamy resin layer formed on the base film and containing micro-bubbles.

16. The liquid crystal display as claimed in claim 15, wherein the plurality of optical sheets further comprise a diffusion sheet and a prism sheet arranged such that the diffusion sheet, the prism sheet and the optical protection sheet are sequentially stacked.

17. The liquid crystal display as claimed in claim 15, further comprising a light guide plate disposed below the plurality of optical sheets, wherein the light source unit comprises a light source disposed on at least one side of the light guide plate, and a reflector disposed around the light source.

18. The liquid crystal display as claimed in claim 15, wherein the light source unit comprises a plurality of lamps, and the plurality of lamps are arranged to be spaced apart from one another at predetermined intervals below the plurality of optical sheets.
